(19) United States
(12) Patent Application Publication
(10) Pub. No.: US 2020/0001486 A1
(43) Pub. Date: Jan. 2, 2020

(54) RIBBON MEASURING DEVICE

(71) Applicant: Jennifer Lynn Matkovich, Lisle, IL (US)

(72) Inventor: Jennifer Lynn Matkovich, Lisle, IL (US)

(21) Appl. No.: 16/021,368

(22) Filed: Jun. 28, 2018

(51) Int. Cl. B26B 29/06; B65H 54/10

(52) U.S. Cl. CPC B26B 29/06; G01B 3/04; B65H 54/10

(57) ABSTRACT

A ribbon measuring device. The ribbon measuring device includes a base having an upper surface and a plurality of openings disposed through the upper surface. The plurality of openings are aligned with one another along a length of the base. The present invention further includes at least two dowels having a bottom end sized to removably fit within each of the plurality of openings. When the two dowels are disposed within two of the plurality of openings, the dowels extend vertically from and are perpendicular to the upper surface.

### BACKGROUND OF THE INVENTION

The present invention relates to ribbons and, more particularly, to a device that is capable of measuring lengths of many ribbons at a time.

Ribbon is used for innumerable useful, ornamental, and symbolic purposes. Cultures around the world use ribbon in their hair, around the body, and as ornamentation on non-human animals, buildings, and packaging. Some popular fabrics used to make ribbons are satin, organza, sheer, silk, velvet, and grosgrain. Cutting and measuring ribbon one at a time can be time consuming and difficult to consistently achieve the same length.

As can be seen, there is a need for a device that is capable of measuring lengths of many ribbons at a time.

### SUMMARY OF THE INVENTION

In one aspect of the present invention, a ribbon measuring device comprises: a base comprising an upper surface and a plurality of openings disposed through the upper surface, wherein the plurality of openings are aligned with one another along a length of the base; and at least two dowels comprising a bottom end sized to removably fit within each of the plurality of openings, wherein when the at least two dowels are disposed within two of the plurality of openings, the at least two dowels extend vertically from and are perpendicular to the upper surface.

In another aspect of the present invention, a method of measuring and cutting ribbon comprises the steps of: providing a ribbon measuring device comprising: a base comprising an upper surface and a plurality of openings disposed through the upper surface, wherein the plurality of openings are aligned with one another along a length of the base; and at least two dowels; placing the two dowels within two of the plurality of openings, wherein a distance between the two dowels is equal to a desired final length of at least one ribbon; holding an end of the ribbon against one of the two dowels; wrapping the ribbon around the other of the two dowels; and cutting a portion of the ribbon that is wrapped around the other of the two dowels.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention;

FIG. 3 is an exploded view of an embodiment of the present invention;

FIG. 4 is a section view of the present invention taken along line 4-4 in FIG. 1;

FIG. 5 is a section view of the present invention taken along line 5-5 in FIG. 1;

FIG. 6 is a section view of the present invention taken along line 6-6 in FIG. 1; and

FIG. 7 is a flow chart of an embodiment of a method of measuring ribbon of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

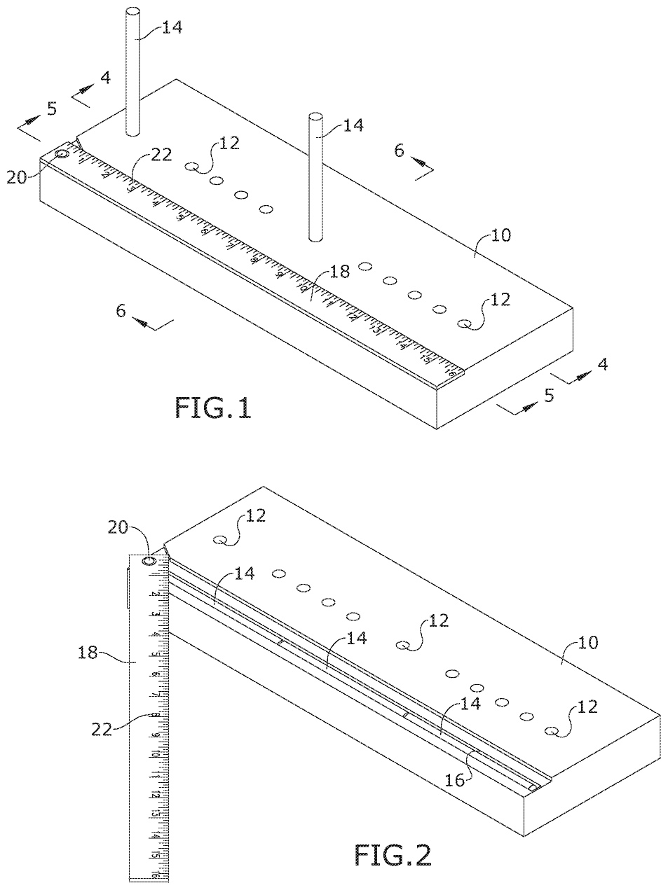

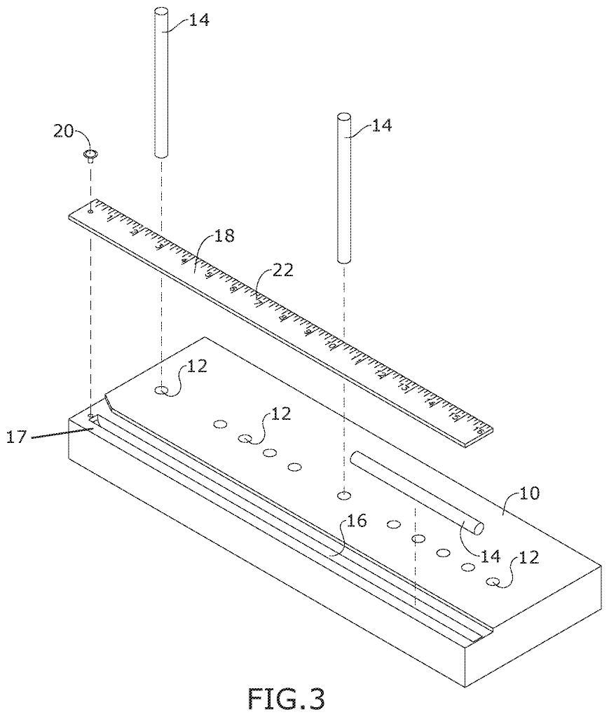

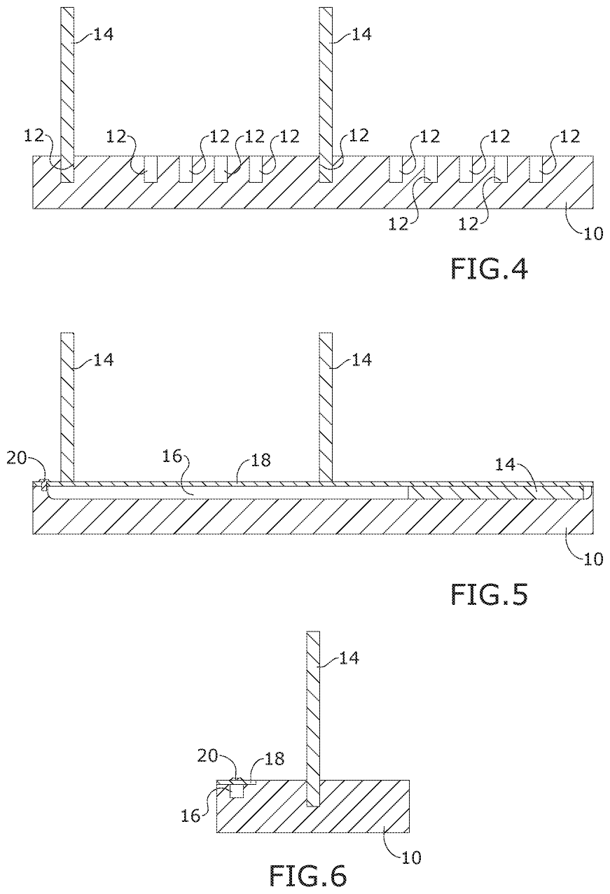

Referring to FIGS. 1 through 6, the present invention includes a ribbon measuring device. The ribbon measuring device includes a base 10 having an upper surface and a plurality of openings 12 disposed through the upper surface. The plurality of openings 12 are aligned with one another along a length of the base 10. The present invention further includes at least two dowels 14 having a bottom end sized to removably fit within each of the plurality of openings 12. When the two dowels 14 are disposed within two of the plurality of openings 12, the dowels 14 extend vertically from and are perpendicular to the upper surface.

In certain embodiments, the openings 12 are spaced apart at least one inch away from one another. This allows a user to easily calculate the distance between multiple openings 12. In certain embodiments, the plurality of openings 12 include a first group of four openings 12 each one inch away from one another, a first single opening 12 two inches from the first group, a second group of four openings 12 each one inch away from one another, and a second single opening 12 two inches from the second group. For example, the openings 12 may be disposed at about at about 3⅝ inches, 4⅝ inches, 5⅝ inches, 6⅝ inches, 8⅝ inches, 10⅝ inches, 12⅝ inches, and 14⅝ inches from an end of the base 10.

The present invention may further include a ruler 18 disposed along the length of the base 10 and parallel relative to the plurality of openings 12. The ruler 18 includes a plurality of measurement markers 22 and is used to easily visualize a distance between two openings 12. In such embodiments, the upper surface of the base 10 further includes a recess 17 formed along the length. The ruler 18 is disposed within the recess 17. An end of the ruler 18 may be pivotally secured to the base 10 within the recess 17 by a pivot post 20.

The present invention may further include a slot 16 formed through the base 10 for storing the dowels 14 within when the ribbon measuring device is not in use. The slots 16 may be formed on the ends of the base 10 or formed within the recess 17. The slot 16 is sized to receive the dowels 14 within. In such embodiments, the ruler 18 may act as a cover. For example, the ruler 18 may be pivoted away from the base 10, exposing the slot 16. The dowels 14 may be removed from the slot 16 and placed within the openings 12 for use. When finished with the present invention, the dowels 14 are removed and placed back into the slot 16. The ruler 18 is then pivoted back towards the base 10, thereby covering the slot 16 and dowels 14, and preventing the dowels 14 from falling out of the slot 16.

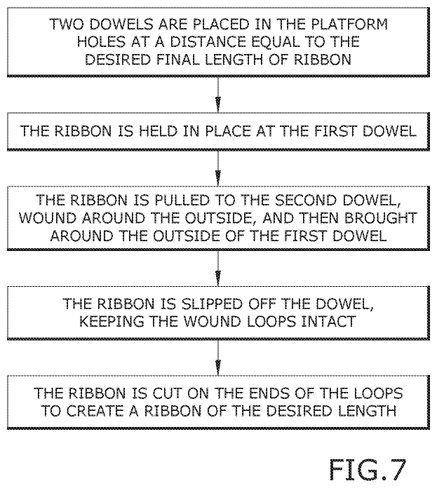

Referring to FIG. 7, a method of measuring and cutting ribbon may include the following steps. Provide the ribbon measuring device described above. Two dowels are placed in the platform holes at a distance equal to the desired final length of the ribbon. The ribbon is held in place at the first dowel. The ribbon is pulled to the second dowel, wound around the outside, and then brought around the outside of the first dowel. The ribbon is slipped off the dowel, keeping the wound loops intact. The ribbon is then cut on the ends of the loops to create multiple ribbons at the desired length.

An exemplary method of making the present invention may include the following. A 2×6 inch piece of lumber is used for the base and ⅜ inch diameter cylinder shaped dowel rods are cut to a length of 5¾ inches each. The piece of lumber is cut to about a 16 inch length. Measure and mark the base for openings at 3⅝ inches, 4⅝ inches, 5⅝ inches, 6⅝ inches, 8⅝ inches, 10⅝ inches, 12⅝ inches, and 14⅝ inches from an end of the base in a row. Then a ⅜ inch drill bit is used to drill the holes for the ⅜ inch diameter dowel rods that are used for guides to wind the ribbon around at the exact measurements for the project.

It should be understood, of course, that the foregoing relates to exemplary embodiments of the invention and that modifications may be made without departing from the spirit and scope of the invention as set forth in the following claims.

What is claimed is:

1. A ribbon measuring device comprising:
a base comprising an upper surface and a plurality of openings disposed through the upper surface, wherein the plurality of openings are aligned with one another along a length of the base; and
at least two dowels comprising a bottom end sized to removably fit within each of the plurality of openings, wherein
when the at least two dowels are disposed within two of the plurality of openings, the at least two dowels extend vertically from and are perpendicular to the upper surface.

2. The ribbon measuring device of claim 1, wherein the plurality of openings are spaced apart at least one inch away from one another.

3. The ribbon measuring device of claim 2, wherein the plurality of openings comprise a first group of four openings each one inch away from one another, a first single opening two inches from the first group, a second group of four openings each one inch away from one another, and a second single opening two inches from the second group.

4. The ribbon measuring device of claim 1, further comprising a ruler disposed along the length of the base and parallel relative to the plurality of openings.

5. The ribbon measuring device of claim 4, wherein the upper surface of the base further comprises a recess formed along the length, wherein the ruler is disposed within the recess.

6. The ribbon measuring device of claim 5, wherein an end of the ruler is pivotally secured to the base.

7. The ribbon measuring device of claim 5, further comprising a slot formed within the recess and sized to receive the at least two dowels within.

8. A method of measuring and cutting ribbon comprising the steps of:
providing a ribbon measuring device comprising:
a base comprising an upper surface and a plurality of openings disposed through the upper surface, wherein the plurality of openings are aligned with one another along a length of the base; and
at least two dowels;
placing the two dowels within two of the plurality of openings, wherein a distance between the two dowels is equal to a desired final length of at least one ribbon;
holding an end of the ribbon against one of the two dowels;
wrapping the ribbon around the other of the two dowels; and
cutting a portion of the ribbon that is wrapped around the other of the two dowels.
